(19) United States
(12) Patent Application Publication
(10) Pub. No.: US 2007/0140215 A1
(43) Pub. Date: Jun. 21, 2007

(54) Methods and systems for providing voice network services using regulated and unregulated telecommunications infrastructures

(76) Inventor: Tingting Lu, Alpharetta, GA (US)

Correspondence Address: MYERS BIGEL SIBLEY & SAJOVEC, P.A., P.O. BOX 37428, RALEIGH, NC, 27627, US

(21) Appl. No.: 11/300,889

(22) Filed: Dec. 15, 2005

(51) Int. Cl. H04L 12/66

(52) U.S. Cl. 370/352

(57) ABSTRACT

Provision of voice telephony services includes providing government-regulated subscriber line transport using a first telecommunications infrastructure that includes analog and digital subscriber lines, and providing a non-government-regulated packet-based telephony (e.g., VoN) service for the digital subscriber lines and at least some of the analog subscriber lines using a second telecommunications infrastructure including a packet data communications network coupled to the first telecommunications infrastructure.

### FIELD OF THE INVENTION

The present invention relates to telecommunications service provision and, more particularly, to methods and systems for providing telephony services.

### BACKGROUND OF THE INVENTION

Packet-based telephony services, also referred to herein as Voice-Over Network (VoN), Voice-Over Internet Protocol (VoIP), and/or Internet Protocol Telephony (IP Telephony) services, are becoming increasingly popular due, in part, to marked improvements in reliability and sound quality of such services. Typically, to provide packet-based telephone communications at a customer premises, interface equipment, such as Integrated Access Devices (LADs), Analog Terminal Adaptors (ATAs), telephone adapters (TAs), and the like, is installed at the customer premises. The equipment is used to support a voice path through a broadband connection, such as a digital subscriber line (DSL) connection or cable television (CATV) connection, back to an Internet Service Provider (ISP). Customers/subscribers can connect their existing analog phones, for example, Plain Old Telephone Service (POTS) phones, to the interface equipment. The interface equipment may provide telephone functions, such as dial tone, battery, and power ringing.

It is envisioned that, as the popularity of packet-based telephony services increases, services providers, e.g., /local exchange carriers (LECs), will eventually migrate their subscriber base from traditional circuit-switched telephony services to packet-based telephony. In particular, it is envisioned that traditional telephone subscribers and broadband subscribers will eventually all be served by a packet-based telephony, while offering the opportunity for subscribers to obtain “bundled” services that include such telephone service with internet service, IP television (IPTV) and/or other packet-based services.

FIG. 1 illustrates a possible network configuration after such migration. Customer premises 10, 20, 30 may be served by an analog subscriber line (ASL), a digital subscriber line (DSL), or a combination of both ASL and DSL, respectively. For example, the ASL-only customer premises 10 may possess only traditional telephone equipment, without broadband service capability. The DSL-only premises 20 may receive internet service, and may also possess interface equipment, such as an IAD, ATA, telephone adapters (TAs), and the like, to provide voice telephony services at the premises 20. The DSL/ASL premises 30 may include both traditional telephone equipment and DSL-compatible hardware.

The customer premises are coupled to a Digital Subscriber Line Access Multiplexer (DSLAM) 100 that is configured to convert analog voice data received from the ASL lines of the ASL-only and DSL/ASL premises 10, 30 to digital packets, and to convert digital voice data in packets received at the DSLAM 100 to analog voice signals transmitted on the ASL lines. The DSLAM 100 also conveys digital packets to and from the DSL lines of the DSL-only and DSL/ASL premises. As shown, the DSLAM 100 is coupled to a packet network, here shown as including an Asynchronous Transfer Mode (ATM) or Ethernet network 50 and an Internet Protocol/Multi-Protocol Label Switching (IP/MPLS) network 60. A VoN network 70 supports packet-based voice telephony for the premises 10, 20, 30. A gateway 80 couples the digital network to a public switched telephone network (PSTN) 90.

FIG. 2 illustrates a network structure 200 for current telecommunications services. Physical facility/transport (local loop), telephone-based number access (both ASL and DSL), circuit-switched network, DSL lines and POTS voice service are all subject to government regulation, e.g., performance, reliability and reporting requirements dictated by the Federal Communications Commission (FCC). IP network and data services (e.g., internet service) are provided in an unregulated fashion, as shown by the shading in FIG. 2. FIG. 3 illustrates a new network structure 300 that is anticipated will be in place in 2006. In the network structure 300, DSL will be divorced from telephone number association and will migrate to a circuit identification association, so that ASL-DSL and DSL-only premises may both be supported. It is envisioned that this will provide a platform for bundled IP-based services, such as VoN, IPTV and data services.

### SUMMARY OF THE INVENTION

According to some embodiments of the present invention, methods of providing telecommunications services include providing government-regulated subscriber line transport using a first telecommunications infrastructure that includes analog and digital subscriber lines, and providing a non-government-regulated packet-based telephony service (e.g., VoN, VoIP or the like) for the digital subscriber lines and at least some of the analog subscriber lines using a second telecommunications infrastructure including a packet data communications network coupled to the first telecommunications infrastructure. The packet data communications network may be coupled to the analog subscriber lines and the digital subscriber lines without an intervening circuit-switched network. For example, the packet data communications network may be coupled to the analog subscriber lines at a digital subscriber line access multiplexer (DSLAM) that is configured to interface analog telephone lines to the packet data communications network.

In further embodiments, the packet data communications network includes a first packet data communications network, and a government-regulated packet-based telephony service is provided for a subset of the analog subscriber lines using a third telecommunications infrastructure including a second packet data communications network coupled to the first telecommunications infrastructure. The subset of analog subscriber lines may correspond to telephone lines that do not support digital subscriber line transport. Provision of a government-regulated Packet-based telephony service for a subset of the analog subscriber lines using a third telecommunications infrastructure may include providing a plain old telephone service (POTS) replacement service for the subset of analog subscriber lines using the third telecommunications infrastructure.

In additional embodiments of the present invention, providing a non-government-regulated packet-based telephony service for the digital subscriber lines and at least some of the analog subscriber lines may include providing the non-government-regulated packet-based telephony service for analog subscriber lines corresponding to telephone lines that do not support digital subscriber line transport. The analog subscriber lines corresponding to telephone lines that do not support digital subscriber line transport may be transitioned from an analog POTS service to the non-government-regulated Packet-based telephony service using a mass local number portability telephone number porting process.

Additional embodiments of the present invention provide systems for providing telecommunications services. A first telecommunications infrastructure is configured to provide government-regulated subscriber line transport to a population of subscribers, the first infrastructure including analog subscriber lines and digital subscriber lines. A second telecommunications infrastructure is configured to provide a non-government-regulated packet-based telephony service for the digital subscriber lines and at least some of the analog subscriber lines, the second telecommunications infrastructure including a packet data communications network coupled to the first telecommunications infrastructure. The packet data communications network may be coupled to the analog subscriber lines and the digital subscriber lines without an intervening circuit-switched network, e.g., at a digital subscriber line access multiplexer (DSLAM) that is configured to interface analog telephone lines to the packet data communications network. The second infrastructure may include a first packet data communications network configured to provide the non-government-regulated packet-based telephony service for the digital subscriber lines and the at least some of the analog subscriber lines and the system may further include a third telecommunications infrastructure configured to provide a government-regulated packet-based telephony service for a subset of the analog subscriber lines over a second packet data communications network coupled to the first telecommunications infrastructure.

### BRIEF DESCRIPTION OF THE DRAWINGS

FIG. 1 illustrates a network configuration for providing VoN and other telecommunications services.

FIGS. 2 and 3 illustrate conventional network structures for delivery of voice and other telecommunications services.

FIGS. 4-6 illustrate network structures for delivery of packet-based telephony service and other telecommunications services according to various embodiments of the present invention.

FIGS. 7 and 8 illustrate network configurations for delivery of packet-based telephony service and other telecommunications services according to further embodiments of the present invention.

FIGS. 9 and 10 are flowcharts illustrating exemplary operations according to some embodiments of the present invention.

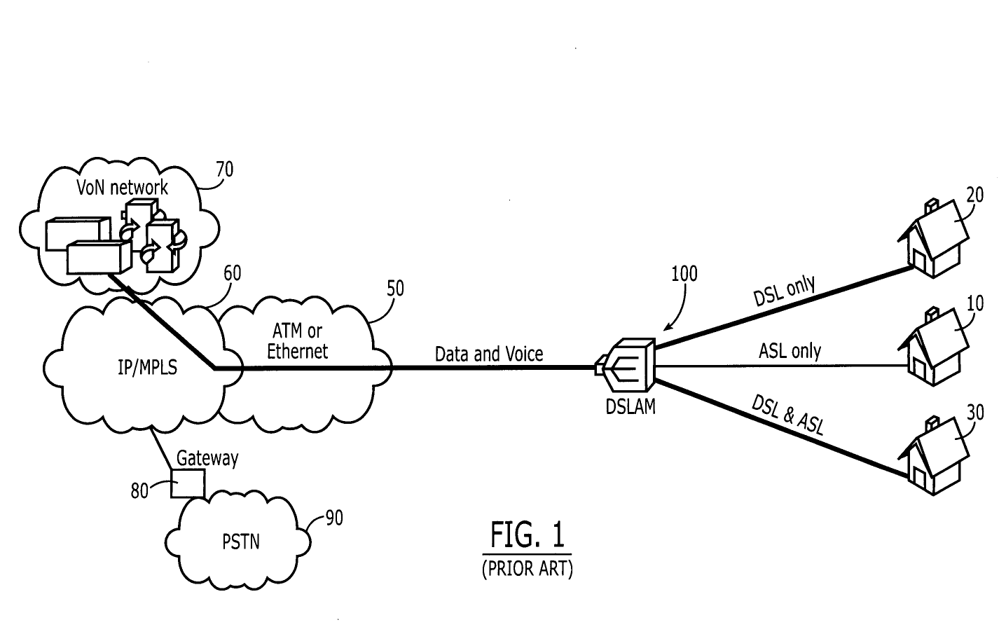

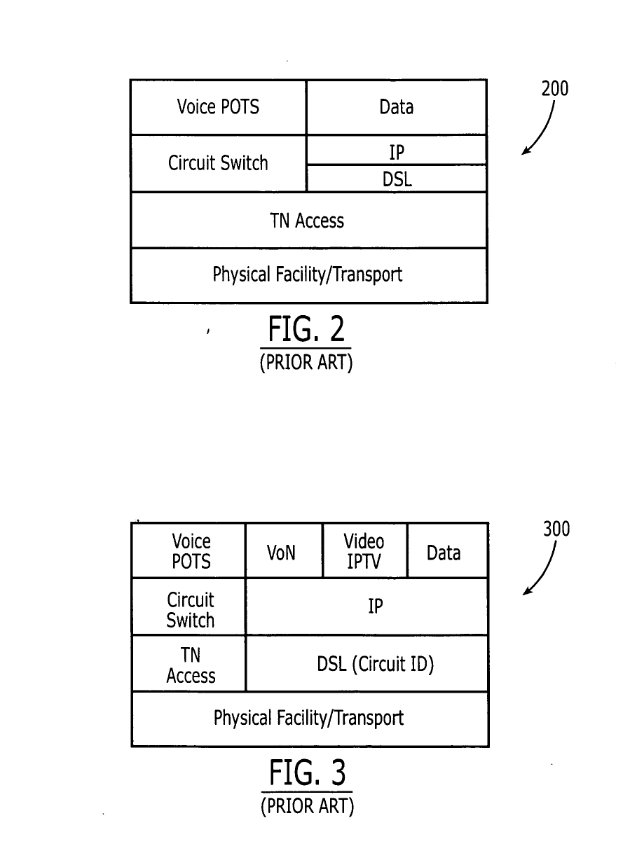

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems and methods. The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations described herein may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention relate to the provision of voice telephony services and, more particularly, to provision of packet-based telephony services. As used herein, “packet-based telephony services” may include Voice over Network (VoN) services, Voice-Over Internet Protocol (VoIP), Internet Protocol Telephony (IP Telephony) and other forms of telephony involving transmission of voice data use of packet communications over digital networks in place of traditional circuit-switched infrastructure.

In various exemplary embodiments of the present invention discussed herein, telecommunications services may be structured to use government-regulated subscriber line transport for a population of subscribers over a subscriber line infrastructure that includes analog and digital subscriber lines. A non-government-regulated voice-over-network (VoN) service may be provided for the digital subscriber lines and at least some of the analog subscriber lines over a non-government-regulated infrastructure including a packet data communications network that is coupled to the subscriber line infrastructure, for example, at a DSLAM that services the analog and digital subscriber lines. In some embodiments, for example, a network structure may include regulated physical transport (e.g., local loop) and regulated analog and digital subscriber lines, which are served by an unregulated packet network that supports bundled IP-based services that include VoN service. In other embodiments, a separate regulated packet network and VoN service may be provided for ASL-only subscribers as a VoN-based POTS replacement, while “whole house” ASL and DSL-only subscribers may be served by an unregulated packet network and VoN service.

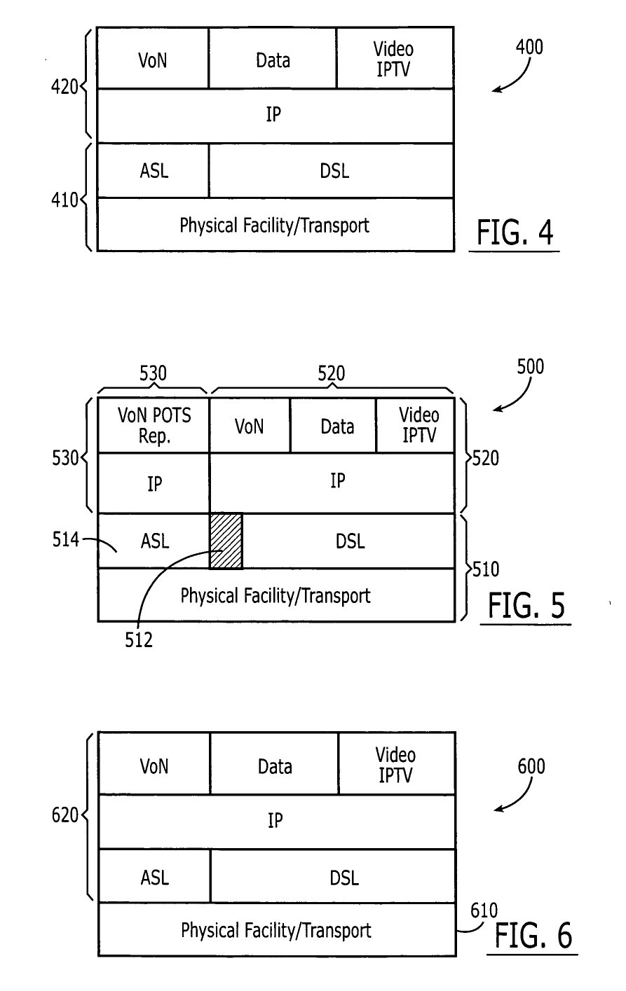

FIGS. 4 and 5 illustrate respective network structures 400, 500 and operations thereof according to some embodiments of the present invention. In particular, the network structures 400, 500 are illustrated as “layered” models including physical, transport and application layers. It will be appreciated that, generally, the various layers 400, 500 may be implemented using any of a number of different arrangements of hardware, e.g., telephone lines, DSLAMs, packet switches, servers, routers and the like, and software configured to execute on such hardware to provide the functionality illustrated.

Referring to FIG. 4, the structure 400 includes a government-regulated infrastructure 410 including a physical transport component that supports analog subscriber lines ASL and digital subscriber lines DSL. An unregulated transport and application infrastructure 420 operates on the regulated infrastructure 410, and includes an IP packet transport layer and applications including VoN, data and IPTV applications.

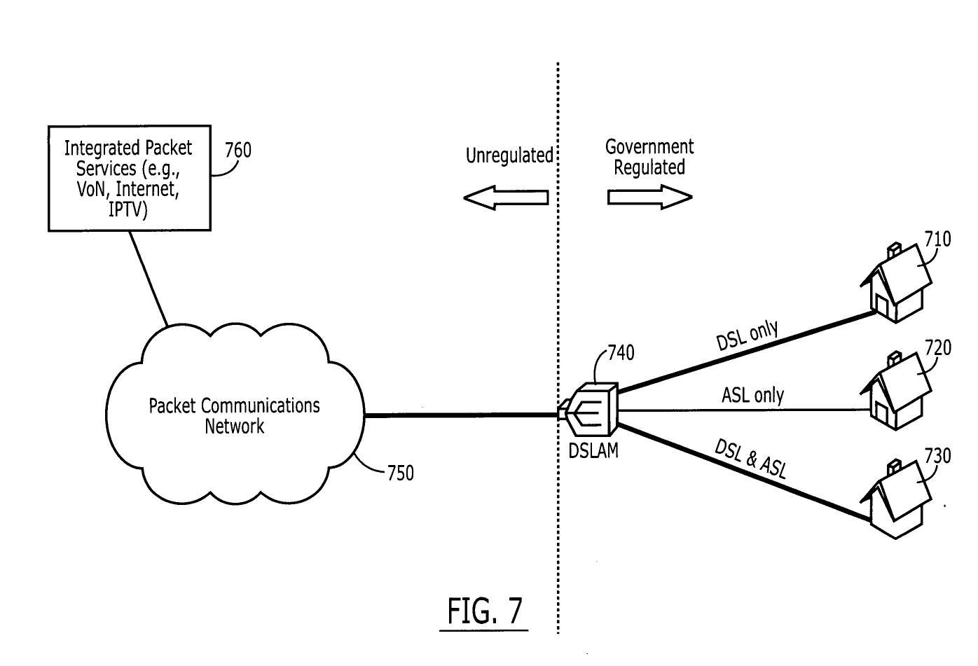

In terms of network configurations, such a structure may be implemented as shown in FIG. 7. Respective DSL-only, ASL-only and DSL/ASL customer premises 710, 720, 730 are coupled to a DSLAM 740 that provides transport and conversion functions. As shown, the DSLAM 740 and downstream network infrastructure may be government-regulated. Coupled to the DSLAM 740 is a non-government regulated packet communications network 750, e.g., an IP and/or MPLS network, that couples the DSLAM to infrastructure 760 (e.g., servers, routers, mass storage, and the like) that provide non-government regulated packet services including VoN, internet, IPTV and the like.

Referring to FIG. 5, according to further embodiments of the present invention, it may be desirable migrate telephone (voice) service to VoN while retaining end-to-end government regulation. As shown in FIG. 5, a network structure 500 may include a government-regulated infrastructure 510 including a physical transport component that supports analog subscriber lines ASL and digital subscriber lines DSL, similar to the infrastructure 410 shown in FIG. 4. The digital subscriber lines DSL and at least a portion 512 of the analog subscriber lines ASL may be served by an unregulated infrastructure 520 including transport IP and applications along the lines discussed above with reference to FIG. 4. Another portion 514 of the analog subscriber lines ASL, e.g., lines corresponding to ASL-only customer premises, may be separately served by a government-regulated infrastructure 530 that provides packet transport and VoN service. For example, the regulated VoN may provide POTS replacement for ASL-only customers.

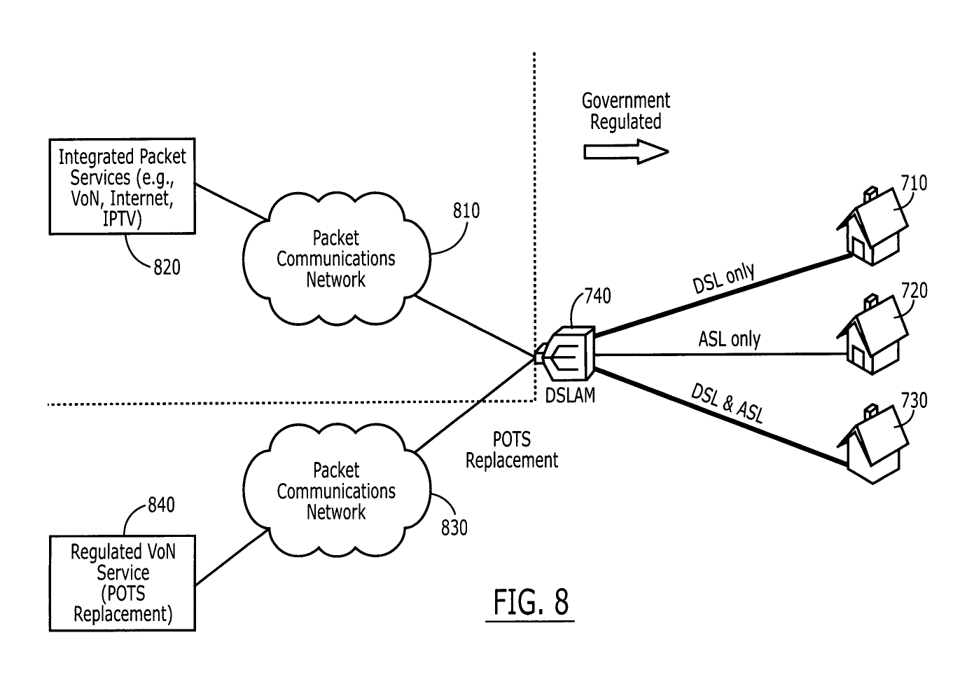

In terms of network configurations, such a structure may be implemented as shown in FIG. 8. DSL-only, ASL-only and DSL/ASL customer premises 710, 720, 730 are coupled to a DSLAM 740 that provides transport and conversion functions. As shown, the DSLAM 740 and downstream network infrastructure may be government-regulated. Coupled to the DSLAM 740 is a first, non-government regulated packet communications network 810, e.g., an IP and/or MPLS network, that couples the DSLAM 740 to infrastructure 760 (e.g., servers, routers, mass storage, and the like) that provide non-government regulated packet services including VoN, internet, IPTV and the like, to the DSL-only and DSL/ASL premises 710, 730. Another, government-regulated infrastructure including a packet communications network 830 and infrastructure 840 for providing regulated VoN service is coupled to the DSLAM 740.

FIG. 6 illustrates a structure 600 that may be a business/regulatory end state that may be desired by a telecommunications provider. In the structure 600, only physical transport (e.g. lines) 610 is subject to government regulation, such that ASL and DSL functionality is combined with packet transport and applications in an unregulated infrastructure 620. It will be appreciated that either of the configurations illustrated in FIGS. 4 and 5 may migrate to such a configuration.

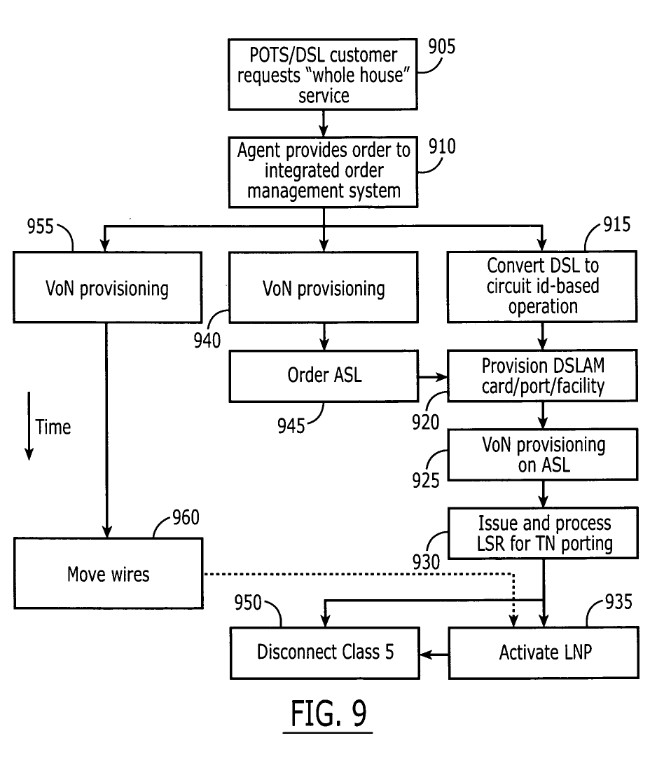

FIG. 9 illustrates exemplary operations for migration of a customer having DSL service for internet and other data and traditional POTS telephone service on ASL to a “whole house” service in which the traditional POTS services is replaced with a VoN service on ASL. The customer submits a request for whole house service, e.g., to an automated (on-line) or live agent (block 905). In response, the agent provides an order to an integrated order management system (block 910). The order management system initiates a series of operations, which may, as shown, occur in parallel.

The customer's DSL is converted from a telephone number association to a circuit identifier association (block 915). In parallel, VoN provisioning in the packet network may occur (block 940), along with generation of an order for ASL (block 945). Responsive to the DSL conversion and ASL order, a DSLAM card/port/facility may be provisioned for the new VoN service (block 920), and VoN service provisioned to the ordered ASL (block 925). A Local Service Request (LSR) is then issued for telephone number porting (block 930) and, in response to the LSR, LNP porting may be activated (block 935) and the customer disconnected from the Class 5 switch (block 950).

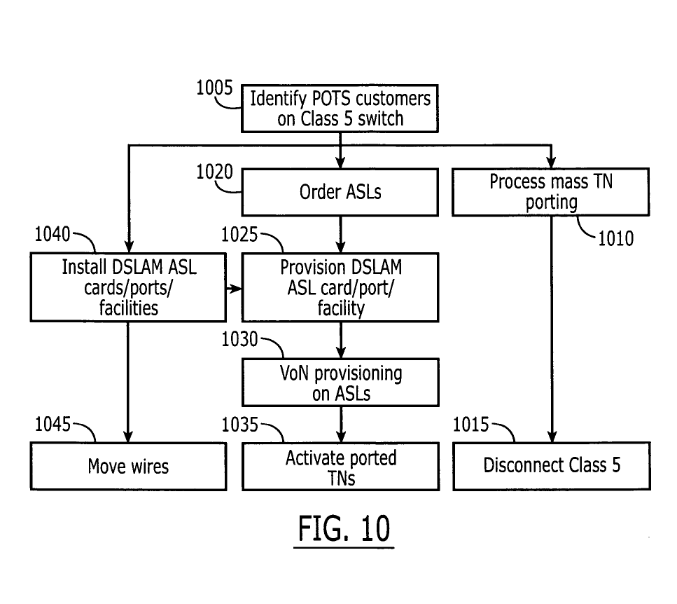

Technician operations may occur in parallel with the above-described operations. In particular, a technician may be dispatched responsive to the integrated order management system (block 955), leading to movement of wires for the customer premises to the provisioned DSLAM (block 960). As shown in FIG. 10, LNP activation (block 935) may be conditioned upon completion of the wiring change (block 960).

FIG. 10 illustrates exemplary operations for mass switching of traditional POTS customers over to a VoN-based POTS replacement service, such as that described above with reference to FIGS. 5 and 8, according to further embodiments of the present invention. A plurality of POTS customers associated with a particular Class 5 switch is identified (block 1005). Responsive to this identification, parallel processes to provision and port telephone numbers of these customers may be initiated. Required DSLAM cards/ports/facilities are installed (block 1040), which may occur in parallel with ordering of ASLs (block 1020). The needed ASL card/ports/facilities are provisioned (block 1025) and VoN provisioned to the ASLs (block 1030). In parallel with these actions, a mass telephone number porting may be conducted (block 1010), followed by disconnection of the customers from the Class 5 switch (block 1015). The ported telephone numbers may be activated for the provisioned ASLs (block 1035) before, after and/or concurrent with moving wires (block 1045).

The flowcharts of FIGS. 9 and 10 illustrate architecture, functionality, and operations of some embodiments of methods and systems according to some embodiments of the present invention. In this regard, each block may represent a module, segment, or portion of code, which includes one or more executable instructions for implementing the specified logical function(s). It should also be noted that in other implementations, the function(s) noted in the blocks may occur out of the order indicated. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of providing telecommunications services, the method comprising:
providing government-regulated subscriber line transport using a first telecommunications infrastructure that includes analog and digital subscriber lines; and
providing a non-government-regulated packet-based telephony service for the digital subscriber lines and at least some of the analog subscriber lines using a second telecommunications infrastructure including a packet data communications network coupled to the first telecommunications infrastructure.

2. The method of claim 1, wherein the packet data communications network is coupled to the analog subscriber lines and the digital subscriber lines without an intervening circuit-switched network.

3. The method of claim 2, wherein the packet data communications network is coupled to the analog subscriber lines at a digital subscriber line access multiplexer (DSLAM) that is configured to interface analog telephone lines to the packet data communications network.

4. The method of claim 1, wherein the packet data communications network comprises a first packet data communications network, and wherein the method further comprises providing a government-regulated packet-based telephony service for a subset of the analog subscriber lines using a third telecommunications infrastructure including a second packet data communications network coupled to the first telecommunications infrastructure.

5. The method of claim 4, wherein the subset of analog subscriber lines correspond to telephone lines that do not support digital subscriber line transport.

6. The method of claim 4, wherein providing a government-regulated packet-based telephony service for a subset of the analog subscriber lines using a third telecommunications infrastructure comprises providing a plain old telephone service (POTS) replacement service for the subset of analog subscriber lines using the third telecommunications infrastructure.

7. The method of claim 1, wherein providing a non-government-regulated packet-based telephony service for the digital subscriber lines and at least some of the analog subscriber lines comprises providing the non-government-regulated packet-based telephony service for analog subscriber lines corresponding to telephone lines that do not support digital subscriber line transport.

8. The method of claim 7, further comprising transitioning the analog subscriber lines corresponding to telephone lines that do not support digital subscriber line transport from an analog POTS service to the non-government-regulated packet-based telephony service using a mass local number portability telephone number porting process.

9. The method of claim 1, further comprising providing a multimedia service integrated with the non-government-regulated packet-based telephony service for at least some of the digital subscriber lines over the digital communications network.

10. The method of claim 9, wherein the multimedia service comprises an internet and/or a video service.

11. A system for providing telecommunications services, the method comprising:
a first telecommunications infrastructure configured to provide government-regulated subscriber line transport to a population of subscribers, the first infrastructure including analog subscriber lines and digital subscriber lines; and
a second telecommunications infrastructure configured to provide a non-government-regulated packet-based telephony service for the digital subscriber lines and at least some of the analog subscriber lines, the second telecommunications infrastructure including a packet data communications network coupled to the first telecommunications infrastructure.

12. The system of claim 11, wherein the packet data communications network is coupled to the analog subscriber lines and the digital subscriber lines without an intervening circuit-switched network.

13. The system of claim 13, wherein the packet data communications network is coupled to the analog subscriber lines at a digital subscriber line access multiplexer (DSLAM) that is configured to interface analog telephone lines to the packet data communications network.

14. The system of claim 11, wherein the second infrastructure comprises a first packet data communications network configured to provide the non-government-regulated packet-based telephony service for the digital subscriber lines and the at least some of the analog subscriber lines and further comprising a third telecommunications infrastructure configured to provide a government-regulated packet-based telephony service for a subset of the analog subscriber lines over a second packet data communications network coupled to the first telecommunications infrastructure.

15. The system of claim 14, wherein the subset of analog subscriber lines correspond to telephone lines that do not support digital subscriber line transport.

16. The system of claim 14, wherein the third telecommunications infrastructure is configured to provide a plain old telephone service (POTS) replacement service for the subset of analog subscriber lines.

17. The system of claim 11, wherein the second telecommunications infrastructure is configured to provide the non-government-regulated packet-based telephony service for analog subscriber lines corresponding to telephone lines that do not support digital subscriber line transport.

18. The system claim 17, further comprising means for transitioning the analog subscriber lines corresponding to telephone lines that do not support digital subscriber line transport from an analog POTS service to the non-government-regulated packet-based telephony service using a mass local number portability telephone number porting process.

19. The system of claim 11, wherein the second telecommunications infrastructure is configured to provide a multimedia service integrated with the non-government-regulated packet-based telephony service for at least some of the digital subscriber lines.

20. The system of claim 19, wherein the multimedia service comprises an internet and/or a video service.
